(19) United States
(12) Patent Application Publication
(10) Pub. No.: US 2026/0320611 A1
(43) Pub. Date: Oct. 15, 2026

(54) SYSTEMS AND METHODS FOR RISK IDENTIFICATION BASED ON PEER-TO-PEER MEMO FIELD CONTENT

(71) Applicant: Capital One Services, LLC, McLean, VA (US)

(72) Inventors: Daniel Wooten, Gastonia, NC (US); Meera Das, Vienna, VA (US); Hongshuang Li, Sharon, MA (US); Kishore Karra, Livingston, NJ (US); Utkarsh Sharma, Reston, VA (US)

(73) Assignee: Capital One Services, LLC, McLean, VA (US)

(21) Appl. No.: 19/173,982

(22) Filed: Apr. 9, 2025

(51) Int. Cl. G06Q 20/40; G06F 40/205; G06F 40/284; G06F 40/30; G06N 20/20

(52) U.S. Cl. CPC G06Q 20/4016; G06N 20/20; G06F 40/205; G06F 40/284; G06F 40/30

(57) ABSTRACT

The invention is generally directed at optimizing anti-money laundering (AML) risk detection models using data content of a transaction memo field. Financial institutions, under the anti-money laundering (AML) mandate, are required to reasonably identify and investigate suspicious transactions that indicate AML risk. A growing volume of these transactions are conducted in a peer-to-peer (P2P) modality and many of these transactions include textual information provided by the transaction participants. The invention detailed here generates clear risk-signals from a statistical transform of the P2P memo field and aggregate transaction behavior of the relevant parties. These signals are used in conjunction with other data to produce Suspicious Activity Reports (SARs).

### FIELD OF THE DISCLOSURE

The present disclosure is generally related to training models for risk identification, and more specifically to using peer-to-peer transaction memo field data for training risk identification models.

### BACKGROUND

Financial institutions, under the anti-money laundering (AML) mandate, are generally required to reasonably identify and investigate customer activity that may be indicative of potential money laundering or other financial crimes and to report the suspicious activity to the government or other authorities through suspicious activity reports (SARs). A growing volume of these transactions are conducted in a peer-to-peer (P2P) modality and many of these transactions include textual information provided by the transaction participants.

However, textual content provided, for example, in a transaction memo field are generally unexplored in transaction record monitoring and processing routines and not incorporated into conventional data pipelines implemented for the purpose of risk identification, such as money laundering risk identification.

These and other deficiencies exist. As such, there is need for an improved system and process for enabling transaction risk assessment based on a statistical transform of the P2P memo field and aggregate transaction behavior of the relevant parties.

### SUMMARY OF THE DISCLOSURE

One aspect of the present disclosure is directed to providing a more effective risk coverage using machine learning (ML) models that focuses on predicting the probability of money laundering behavior by using a comprehensive set of variables available within the data including a memo field content generally associated with peer-to-peer (P2P) transactions. One aspect of the disclosed system and process is directed to a novel application of memo field data for training risk identification models. As memo field data may often include arbitrary and/or non-descriptive language, one exemplary implementation for enabling incorporation of memo field data into a system and/or process for training risk identification models may involve an initial data processing operation customized for memo field content.

Once a set of categorical themes, derived based on an analysis of memo field content from transactional data, are identified, customer P2P transactions may be tagged to themes if the transaction memo field contains words related to the theme. The association of transactions with a new measurement parameter, ‘theme,’ allows for new statistical analysis and information. The new information, associated with the ‘theme’ measurement parameter, is then statistically combined with other transaction related information, such as amount and direction of transaction to generate input features and parameters that may be used, by a risk model, for generation of risk/no-risk signals for the purpose of identifying suspicious transaction activity at the user level.

Accordingly, one aspect of the disclosure is directed at the specific application of memo field data for generation of a hybrid textual-transactional statistical signals (e.g., for inputting into risk-assessment model) as well as the corresponding adaptations of data processing features for enabling the process (e.g., generation of categorical memo themes and/or indicators and specific implementation of transaction flagging) as is further described below.

In one embodiment, the disclosed implementation and the system and process associated therewith comprises two primary components. One component involves the construction of thematic categories from analysis of memo fields and association of the corresponding theme indicators with a flag value. The other components involves generation of transaction-level features using, in part, the indicator flags and subsequent generation of model-level features based on aggregation of transaction-level features.

Accordingly, one aspect of the present disclosure is directed to: a method of evaluating risk footprint, the method comprising: compiling, by a processor, a dataset of transaction records with memo field content; identifying, by the processor, a set of categorical themes based on an analysis of the memo field contents in the dataset. In some embodiments, the analysis of memo field contents may comprise identifying one or more key risk terms in the memo field content of the dataset that correspond to memo field contents in known fraud cases. In some examples, the one or more key risk terms may be associated with non-numeric, non-date key risk terms with four or more characters. In some embodiments analysis of memo field contents may comprise compiling a list of most repeated words in the memo fields associated with the dataset of transaction records. In some examples, compiling a list of most repeated words may comprise performing intra and inter memo word frequency analysis on parsed memo field content to generate a list of words that meet the trade-off of having a sufficient common occurrence while also representing a sufficient amount of the memo population.

In some embodiments, the plurality of categorical themes, generated based on an analysis of the memo field contents in a dataset, may comprises one or more themes associated with a presence of one or more negative words in a memo field. In some embodiments, the one or more negative words in the memo field may be identified using a negative sentiment lexicon pattern based on a predetermined threshold.

The method of evaluating risk footprint may further comprise generating, by the processor, one or more memo field indicators for each identified theme, wherein each memo field indicator is associated with a flag value indicating a presence or absence of the memo field indicator in a transaction record. In some embodiments, the identification of one or more terms associated with each categorical theme may be implemented by searching the memo fields for a pattern of words associated with each theme.

The method of evaluating risk footprint may further comprise generating, by the processor, one or more transaction-level features based on a direction of the transaction record, wherein the transaction-level features are computed as a function the flag value and a corresponding transaction amount for each transaction direction. In some embodiments, the one or more transaction-level features, computed for each of the plurality of themes based on the transaction direction, corresponds to the flag value and a product of the flag value with the corresponding transaction amount. In some examples, a transaction amount corresponding to outgoing and incoming transactions may be associated with different limits. In one example, the generation of one or more transaction-level features corresponds to computation of four transaction-level features for each identified theme.

The method of evaluating risk footprint may further comprise generating, by the processor, one or more model-level features by aggregating the one or more transaction-level features based on the direction of a transaction record across all transaction records associated with a user in the dataset of transaction records. The model-level features may comprise an aggregate transaction count and a corresponding aggregate transaction amount associated with each categorical theme, wherein the aggregate transaction count and the aggregate transaction amount for each categorical theme is computed for each transaction direction corresponding to incoming and outgoing transactions associated with the user. In one example, the generation of one or more model-level features corresponds to computation of six model-level features for each identified theme, wherein the one or more model-level features represents a consolidated view of a total incoming amount and a total outgoing amount associated with each memo field indicator for the user.

The method of evaluating risk footprint may further comprise providing, by the processor, the one or more model-level features and a plurality of memo field indicators to a risk assessment model configured to generate a hybrid textual-transactional statistical signal to separate transactions into risky and non-risky populations. The risk assessment model maybe trained to identify a baseline pattern of transaction attributes associated with each identified memo theme, for the user, and isolate transactions that violate the baseline pattern between the identified memo themes and transaction attributes. In some examples, the risk assessment model, for determining a relationship between memo field indicators and transactional features, is trained using an ensemble tree technique.

One aspect of the present disclosure is directed to: a system, comprising: a processor; and a memory storing instructions which when executed by the processor, cause the processor to: identify a set of categorical themes based on analysis of memo fields associated with a dataset of transactions; generate oner or more memo field indicators for each identified theme, wherein each memo field indicator is associated with a flag value indicating a presence or absence of the memo field indicator in a transaction record; generate one or more transaction-level features, based on a direction of the transaction record, wherein the transaction-level features are computed as a function the flag value and a corresponding transaction amount, for each transaction direction; generate one or more model-level features by aggregating the one or more transaction-level features based on the direction of a transaction record across all transaction records associated with a user in the dataset of transaction records; and provide the one or more model-level features and a plurality of memo field indicators to a risk assessment model configured to generate a hybrid textual-transactional statistical signal to separate transactions into risky and non-risky populations.

In some embodiments, the system generates model-level features by aggregating transaction count and a corresponding aggregate transaction amount associated with each categorical theme, wherein the aggregate transaction count and the aggregate transaction amount for each categorical theme is computed for each transaction direction corresponding to incoming and outgoing transactions associated with the user. In some examples, the risk assessment model may be trained to identify a baseline pattern of transaction attributes associated with each identified memo theme, for the user, and isolate transactions that violate the baseline pattern between the identified memo themes and transaction attributes. In some embodiments, the system may compute the one or more transaction-level features, for each of the plurality of themes based on the transaction direction. The one or more transaction-level features may correspond to the flag value and a product of the flag value with the corresponding transaction amount, computed independently for incoming and outgoing transactions. In some embodiments, a transaction amount corresponding to outgoing and incoming transactions may be associated with different limits.

One aspect of the present disclosure is directed to: a non-transitory computer-readable medium containing executable instructions, wherein, when executed by a processor, the instructions cause the processor to perform procedures comprising: identifying a set of categorical themes based on analysis of memo fields associated with a dataset of peer-to-peer transactions; generating one or more memo field indicators for each identified theme, wherein each memo field indicator is associated with a flag value indicating a presence or absence of the memo field indicator in a transaction record; generating one or more transaction-level features, based on a direction of the transaction record, wherein the transaction-level features are computed as a function the flag value and a corresponding transaction amount for each transaction direction; generating one or more model-level features by aggregating the one or more transaction-level features based on the direction of a transaction record across all transaction records associated with a user in the dataset of transaction records; and providing the one or more model-level features and a plurality of memo field indicators to a risk assessment model configured to generate a hybrid textual-transactional statistical signal to separate transactions into risky and non-risky populations.

### BRIEF DESCRIPTION OF THE DRAWINGS

FIG. 1A illustrates an exemplary implementation of transaction-level feature generation with a memo field component, according to an example embodiment.

FIG. 1B illustrates an exemplary set of generated transaction-level features used as input, along with transaction data, into a model-level feature generator, according to an example embodiment.

FIG. 1C illustrates an exemplary table of transaction-level features, according to an example embodiments.

FIG. 1D illustrates an exemplary set of model-level features generated from a set of transaction-level features and transaction data, according to an example embodiment.

FIG. 1E illustrates exemplary process for training a supervised risk identification model utilizing a memo field component, according to an example embodiment.

FIG. 1F illustrates an exemplary table of Model-level features, according to an example embodiments.

FIG. 1G illustrates a hardware implementation system for generation of model-level features, for training a risk model, based on transaction memo content, according to an example embodiment.

FIG. 2 illustrates an operational flow diagram for generation of risk model training parameters based on transaction memo content, according to an example embodiment.

FIG. 3 illustrates a timing sequence diagram for generation of risk model training parameters based on transaction memo content, according to an example embodiment.

FIG. 4 illustrates an exemplary table of model performance values for the model-level feature set based on two distinct algorithms, according to an example embodiment.

FIG. 5 illustrates a block diagram of an exemplary system according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

In conventional implementations for improving transaction risk monitoring and surveillance capabilities, one unexplored area is incorporation of memo data associated with various transactional monetary instruments, voluntarily inputted by the user. This may be especially relevant with regards to detection of potential money laundering activities based on transactional activity data. Therefore, one aspect of the disclosure is directed to an implementation for utilizing memo field data as a predictors of risk, such as potential money laundering activity, in transaction monitoring systems or models.

As such, one aspect of the disclosure is directed to systems and methods for engineering memo field features into input parameters that may be used for training and testing risk assessment models. In one embodiment this may involve creation of transaction-level features based on processing memo-level information with transaction context data, and generation of corresponding user-level features by combining transaction-level features across all or a subset of transactional activities associated with the user. Accordingly, various aspects of the present disclosure are further directed to a viable approach for extraction of useful information from memo fields, and derivation and/or determination of theme indicators for categorization of memo fields and transaction flagging, using category indicator flags, to facilitate derivation of input process parameters (e.g., input parameters that may be used for training and testing risk assessment models) from memo-level data.

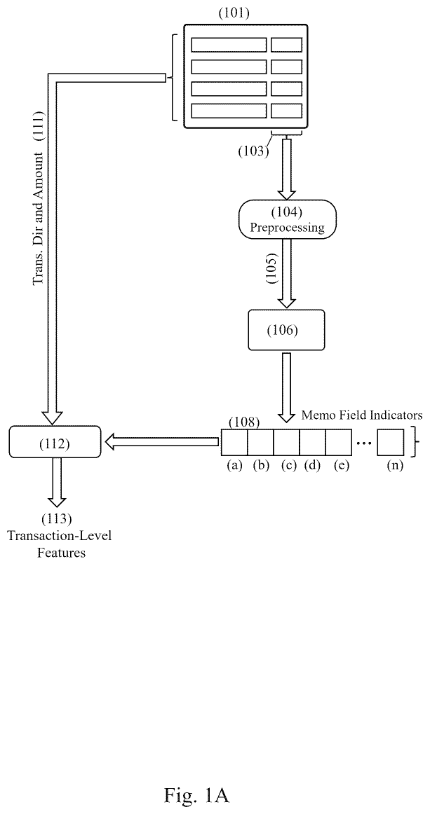

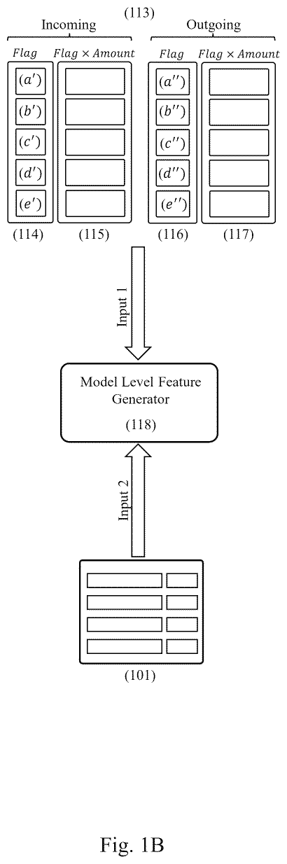

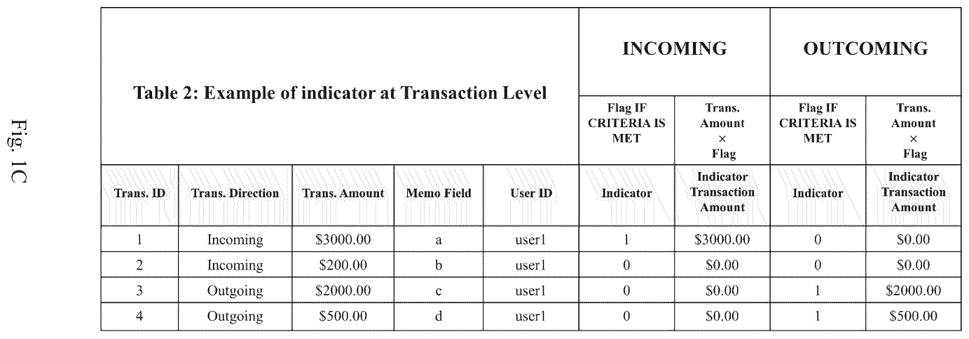

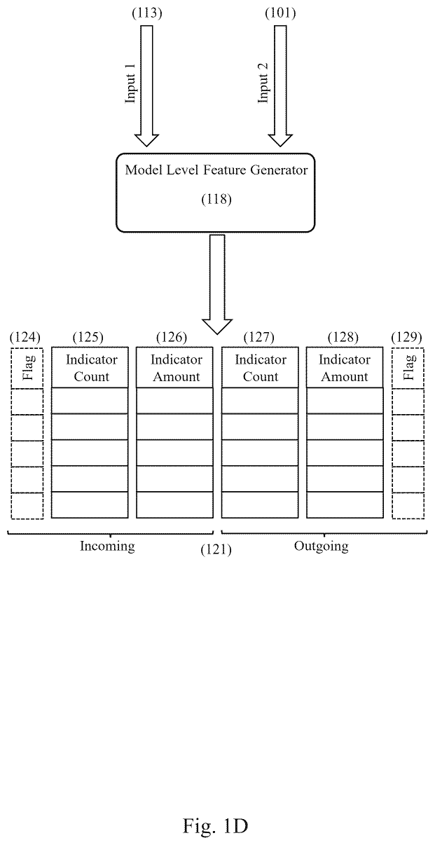

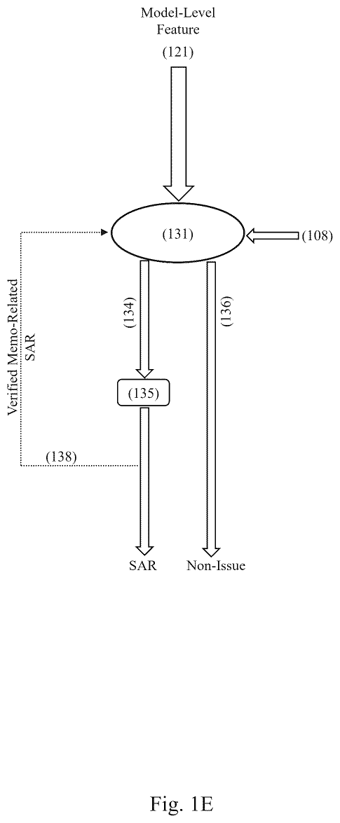

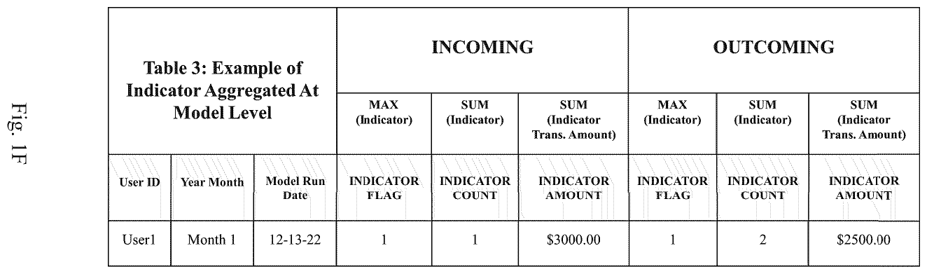

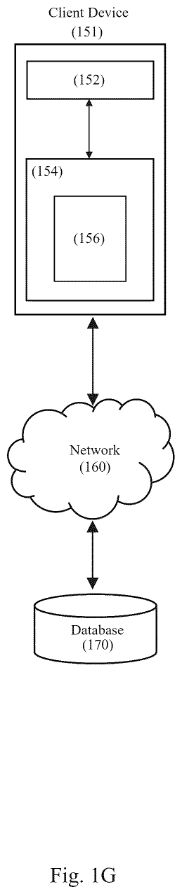

FIG. 1A illustrates an exemplary implementation 100 for generation of intermediary transaction-level features, based on memo data content, to be used in generation of input parameters for a risk model. The operations may be conducted by one or more processes executing on a client device and/or server as illustrated, for example, in FIG. 1G. Memo field data may be retrieved from a centralized data repository (e.g., database 170 illustrated in example 150 of FIG. 1G). With reference to example 100 a subset of transactions which include memo data (e.g., P2P transaction records 101) is provided. The P2P transaction data may comprise transaction-level information about the transaction amount, date of transaction, direction of transaction (e.g., incoming, and/or outgoing transactions) transaction identifiers (IDs) for identifying each transaction, parties involved, banks involved, and the memo data associated with the transaction.

In some embodiments, a data pre-processing operation 104 may be applied to the content of the transaction memo fields 103, in the P2P transaction record dataset 101, prior to initiation of any preliminary exploratory analysis on the data for extraction of theme categories and/or risk-associated character patterns by memo categorizer process/module 106. Data processing implemented at 104 may comprise cleaning up of the text (e.g., removal of punctuations, lowercasing, and extra white spaces) from each memo and parsing of the memo field content into an array of words to facilitate a word-level analysis. In some embodiments, word-level analysis may comprise computation of the frequency of words per memo, the frequency of words across all of the memos in the data, a top words analysis, and utilization of one or more natural language processing (NLP) methods for contextual analysis and characterization of the memo data. Given the limitation corresponding to low occurrence of many words found in the memo fields, additional processing, for determining how many of the top occurring words are needed to cover a large portion of memos, may be conducted. This analysis seeks to identify a list of memo words that meet a trade-off of having a sufficient common occurrence while also representing a sufficient amount of the memo population.

Referring back to exemplary implementation 100, processed list of memo words (e.g., output of preprocessing stage 104) may then be used, by the memo categorizer process/module 106, to identify distinct themes and/or risk-related character patterns in the memo data 103 and generate a set of memo field indicators 108. In one embodiment, memo field indicators 108 may be generated by parsing and processing of the memo field dataset 103 for identifying one or more terms associated with each categorical theme determined by the memo categorizer 106. In some embodiments, the memo categorization process/module 106 may include a human component for analysis of memo field data and identification and categorization of various memo themes and patterns. The human component may be used to implement or supplement the memo data analysis associated with the memo categorization process 106. The goal of this analysis is to uncover specific patterns and themes that could potentially be used as indicators of risk. As shown in exemplary implementation 100, each indicator may be associated with a flag value (a-n) identifying a presence or absence of a specific theme indicator in the transactional data being processed.

According to one exemplary embodiment, to ensure that a wide spectrum of risks are covered, four different avenues, corresponding to key risk terms, prior research and recommendations, word analysis (in this exemplary embodiment, a top 700 word analysis) and negative sentiment word analysis, were taken to identify themes in the memo field. In one exemplary embodiment, exploratory analysis of one or more archives of electronic P2P transactions with associated memo data, based on the aforementioned four criteria involving P2P transactions, resulted in identification of 36 total themes associated with a unique indicator (e.g., n=36 in exemplary implementation 100). Empirical results of the exemplary exploratory analysis of transaction memos are illustrated in Table 1 below:

TABLE 1
Memo Themes Overview

| Criteria to Create Themes | Count of Themes |
|---|---|
| Prior Insights | 14 |
| Top 700 Word Analysis | 18 |
| Negative Sentiment Analysis | 3 |
| Key Risk Term List | 1 |

In some embodiments, the one or more key risk terms, referenced above, may be associated with non-numeric, non-date key risk terms with four or more characters. Memo categories derived from prior insights may represent memo fields that include specific patterns (e.g., long and/or sort memo notations, memos with special characters corresponding, for example, to non-alphanumeric notations) that may be identified in a memo field and used in identification of risky transactions (e.g., AML related risks).

Referring back to exemplary implementation 100, following the creation of themes (to identify potential risk factors within the data) and generation of memo field indicator 108 with associated flag parameter, a next step may involve generation of one or more intermediary operational features at transaction level. The transaction-level features may then be used in generation of input parameters at the Enterprise Customer Identifier (ECID) level in order to provide an understanding of transactional behaviors and context. “ECID level” refers to the unique identifier generated by a system, typically used to track a user's activity across multiple components within that system, allowing for correlation of events related to a single user or device across different parts of the application and/or platform and/or a plurality of P2P transactions conducted by the user.

Referring back to exemplary implementation 100, transactional context input 111, such as transaction direction and transaction amount attributes, may be extracted from the P2P transaction records 101 and processed, along with the generated memo field indicators 108 (e.g., flag values a-n associated with memo field indicators), by a transaction level feature generator 112, to generate a set of (directional) transaction-level features 113, which further incorporates data regarding the presence of the memo themes (based on identification of a theme flag in the memo and the direction of transitions). Transaction direction adds context to the theme flag, enabling the capture of nuanced patterns and behaviors associated with incoming and outgoing transactions. In some embodiments there may be different limits associated with the incoming and outgoing transactions amounts. Subsequently, these features are aggregated to the ECID or model level to ensure an understanding of transactional behaviors and contexts, as further illustrated in FIG. 1B.

Referring back to example 100, with regard to generation of the directional transaction level features 113, if a term from a theme category, identified at 106, is present in the preprocessed memo data (e.g., 105) and the transaction direction is incoming, the flag associated with a corresponding theme indicator (e.g., a-e) for incoming transaction is set to one. Referring now to example 110 illustrated in FIG. 1B, this may correspond flag values (a′-e′), associated with theme indicator flag parameters 114 for incoming transactions, being set to an ON and/or “1” value. Similarly, if a term from a theme category, identified at 106, is present in the memo and the transaction direction is outgoing, the flag associated with a corresponding theme indicator (e.g., a e) for outgoing transaction is set to one. With reference to example 110, this may correspond flag value (a″-e″), associated with theme indicator flag parameters 116 for outgoing transactions, being set to an ON and/or “1” value. The flag values, designated for flag parameters 114 and 116, by the transaction-level feature generator 112, indicate the presence of a theme category (a-n) and the direction of transactions, which as described above adds context to the theme flag, enabling the capture of nuanced patterns and behaviors associated with incoming and outgoing transactions.

Subsequently, as illustrated in example 110 of FIG. 1B, the amount of each transaction is multiplied by the corresponding flag for the theme and the transaction direction to generate transaction-level features 115 and 117 associated respectively with incoming and outgoing transactions. This step ensures that the amount reflects the presence of the theme and the directionality of the transaction. As a result, in accordance with one embodiment illustrated in FIG. 1B, four features (e.g., 114-117) are created at the transaction level for each memo category and/or theme. Empirical results of an exemplary process for generation for transaction-level features/indicators are provided in Table 2, illustrated in FIG. 1C:

Referring back to the exemplary implementation 110 illustrated in FIG. 1B, theme indicator flags 114 and 116 are associated respectively with incoming and outgoing transaction. For illustrative purposes, flag values associated with a memo field theme indicator (a-e) are denoted as (a′-e′) for incoming transactions and (a″-e″) for outgoing transactions. Transaction level features 113 may serve as input data (e.g., input 1) into a model-level feature generation process/module 118 for direction-based aggregation across all the P2P transaction records associated with a user and/or one or more user accounts, (e.g., provided as input 2 into the process/module 118).

FIG. 1D provides a conceptual illustration 120 of an exemplary process for generation of model-level features for training a risk assessment model as a function of memo field data associated with P2P transactions. The generation of model-level features may be implemented by aggregating transaction-level features across a plurality of P2P transactions associated with a user and/or one or more user accounts. The operations may be conducted by one or more processes executing on a client device and/or server as illustrated, for example, in FIG. 1G. The plurality of P2P transactions, including the memo field data, associated with a user and/or one or more user accounts may be retrieved from a centralized data repository (e.g., database 170 illustrated in example 150 of FIG. 1G). Referring back to illustration 120 of FIG. 1D, transaction-level features 113 may be aggregated (e.g., for each user and/or one or more user accounts) across all P2P transaction records in the exemplary dataset 101. Accordingly, a model-level feature generator module 118 may receive input 1, corresponding to transaction-level features generated for each theme (e.g., a-n) and an aggregation input (e.g., input 2) across which input 1 data is aggregated. As described above, input 2 may correspond to one or more transaction records, from the plurality of P2P transaction records 101, associated with a user and/or one or more user accounts.

In accordance with some embodiments, six aggregate transaction-level features, corresponding to six model-level input features, are computed for each derived theme category (represented by memo-field indicator parameters 108) at the output of the model-level feature generator 118. In accordance with some embodiments, one pair of model-level features may correspond to the computation of maximum flags for each theme across all incoming and outgoing transactions associated with a user and/or one or more user accounts (e.g., input 2). This feature indicates whether a theme is present in any transaction associated with the user or the user account. With reference to illustration 120, the maximum flag, associated with each theme, corresponding to incoming and outgoing transaction is denoted respectively by feature sets 124 and 129, respectively.

A second pair of model-level features may correspond to the count of each theme calculated as the sum of flag values across all incoming and outgoing transactions associated with a user and/or one or more user accounts (e.g., input 2). This count represents the total number of transactions where the theme was present for the user or the user account. With reference to illustration 120 the count of each theme corresponding to incoming and outgoing transaction is denoted respectively by feature sets 125 and 127.

A third pair of model-level features may correspond to the amount for each theme aggregated by summing the adjusted incoming and outgoing amounts based on the flag values across all incoming and outgoing transactions associated with a user and/or one or more user accounts. This aggregation provides a consolidated view of the total amount associated with the theme for the user, considering both incoming and outgoing transactions. With reference to illustration 120 the aggregate transaction amount, associated with each theme, for incoming and outgoing transaction is denoted respectively by feature sets 126 and 128. As a result, six features 121 are created at the aggregate level for each theme as illustrated in the exemplary embodiment 120 of FIG. 1D.

Referring now to the exemplary embodiment 130 illustrated in FIG. 1E, aggregated transaction-level features 121 (e.g., aggregated for each theme for a specific user) may then be provided, along with set of theme categories represented, for example, by memo field indicators 108, as inputs into an optimized risk assessment model 131 (e.g., a supervised ML and/or a rule-based risk assessment model). By incorporating these features into a machine learning model, transaction-level information may be effectively leveled, as part of the potential predictive information, to identify occurrences of suspicious transaction activity (e.g., transactions associated with AML risk). With reference to illustration 130, an optimized risk assessment model 131 (e.g., ML-based and/or a rule-based model) optimized for input data 121 and 108, may generate, based on processing of the input data, a risk or a non-risk signals denoted as 134 and 136, respectively. In accordance with some embodiments, during a training window, transaction records identified in the output risk signal 134 may undergo a human review cycle 135 to ensure accurate association of a corresponding memo field data to the generated risk target label (e.g., AML risk). In accordance with some embodiments, a subset of the risky transaction 138, that have cleared the human review cycle 135, may be fed back into the data model 131 during a model training phase to optimize the model performance. In one example a total of 216 model-level features constituting 6 features for each of the 36 themes was generated. Empirical results of an exemplary process for generation for model-level features/indicators are provided in the Table 3, illustrated in FIG. 1F.

Referring back to example 130, the model-level features 121 (e.g., transaction-context feature set) encompasses all transactional features derived from themes and further provides context by bringing the additional information of transaction count and amount associated with each theme for each transaction direction. It may be noted that counts of flags inherently imply the presence of flags, as the count of flags greater or equal to one implies the flag is one. Accordingly, in order to maintain a distinct feature set derived from the memo field content and to prevent issues related to multicollinearity and redundant information, the flag itself (corresponding to feature sets 124 and 129) may be excluded from the feature set 121 for data model 131. This approach ensures that each feature in the model contributes unique information without introducing unnecessary redundancy. Accordingly, in some embodiments, input signal 121 (e.g., corresponding to an output of the model-level feature generator 118) may comprise four model-level (e.g., aggregated transaction-level) features to be utilized by the risk assessment model 131. In some embodiments, risk assessment computation, for generation of risk and/or no risk signals 134 and 136, may involve assignment of different weights to different memo categories (e.g., memo field indicators provided in input 108) by the data model 131.

One aspect of the described process may be facilitated by the exemplary system implementation 150, illustrated in FIG. 1C. Example 150 of FIG. 1G, illustrates an exemplary representation of a client device, network, and a database:

The client device 151 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a wearable device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 151 may include a processor 152, a memory 154, and an application 156. The processor 152 may be a processor, a microprocessor, or other processor, and the client device 151 may include one or more of these processors. The processor 152 may include processing circuitry, which may contain additional components, including additional processors, memories, error and parity checkers, data encoders, anti-collision algorithms, controllers, command decoders, security primitives and tamper-proofing hardware, as necessary to perform the functions described herein.

The processor 152 may be coupled to the memory 154. The memory 154 may be a read-only memory, write-once read-multiple memory or read/write memory, e.g., RAM, ROM, and EEPROM, and the client device 151 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 154 may be configured to store one or more software applications, such as the application 156, and other data, such as user's private data and financial account information.

The application 156 may comprise one or more software applications comprising instructions for execution on the client device 151. In some examples, the client device 151 may execute one or more applications, such as software applications, that enable, for example, network communications with one or more components of the system 150, transmit and/or receive data, and perform the functions described herein. Upon execution by the processor 152, the application 156 may provide the functions described in this specification, specifically to execute and perform the steps and functions in the process flows described herein. Such processes may be implemented in software, such as software modules, for execution by computers or other machines. The application 156 may provide GUIs through which a user may view and interact with other components and devices within the system 150. The GUIs may be formatted, for example, as web pages in HyperText Markup Language (HTML), Extensible Markup Language (XML) or in any other suitable form for presentation on a display device depending upon applications used by users to interact with the system 150.

The client device 151 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the client device 151 that can be available and supported by the client device 151, such as a touch-screen, keyboard, mouse, cursor-control device, touch-screen, microphone, digital camera, video recorder or camcorder. These devices may be used to enter information and interact with the software and other devices described herein.

System 150 may include one or more networks 160. In some examples, the network 160 may be one or more of a wireless network, a wired network or any combination of wireless network and wired network and may be configured to connect the user devices (e.g., mobile device and/or computing device), the client device 151 and the database 170. For example, the network 160 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 160 may include, without limitation, telephone lines, fiber optics, IEEE Ethernet 902.3, a wide area network, a wireless personal area network, a LAN, or a global network such as the Internet. In addition, the network 160 may support an Internet network, a wireless communication network, a cellular network, or the like, or any combination thereof. The network 160 may further include one network, or any number of the exemplary types of networks mentioned above, operating as a stand-alone network or in cooperation with each other. The network 160 may utilize one or more protocols of one or more network elements to which they are communicatively coupled. The network 160 may translate to or from other protocols to one or more protocols of network devices. Although the network 160 is depicted as a single network, it should be appreciated that according to one or more examples, the network 160 may comprise a plurality of interconnected networks, such as, for example, the Internet, a service provider's network, a cable television network, corporate networks, such as credit card association networks, and home networks. The network 160 may further comprise, or be configured to create, one or more front channels, which may be publicly accessible and through which communications may be observable, and one or more secured back channels, which may not be publicly accessible and through which communications may not be observable.

System 150 may include a database 170. The database 170 may be one or more databases configured to store data, including without limitation, private data of users, financial accounts of users, identities of users, transactions of users, and certified and uncertified documents. The database 170 may comprise a relational database, a non-relational database, or other database implementations, and any combination thereof, including a plurality of relational databases and non-relational databases. In some examples, the database 170 may comprise a desktop database, a mobile database, or an in-memory database. Further, the database 170 may be hosted internally by the client device 151 or it may be hosted externally of client device 151, such as by a server, a cloud-based platform, or in any storage device that is in data communication with the client device 151.

In some examples, exemplary procedures in accordance with the present disclosure described herein can be performed by a processing arrangement and/or a computing arrangement (e.g., a computer hardware arrangement). Such processing arrangement and/or a computing arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the client device 151, the network 160, and the database 170 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally or alternatively, a storage arrangement can be provided separately from the computer-accessible medium, which can provide the instructions to the processing arrangement so as to configure the processing arrangement and/or a computing arrangement to execute certain exemplary procedures, processes, and methods, as described herein above, for example.

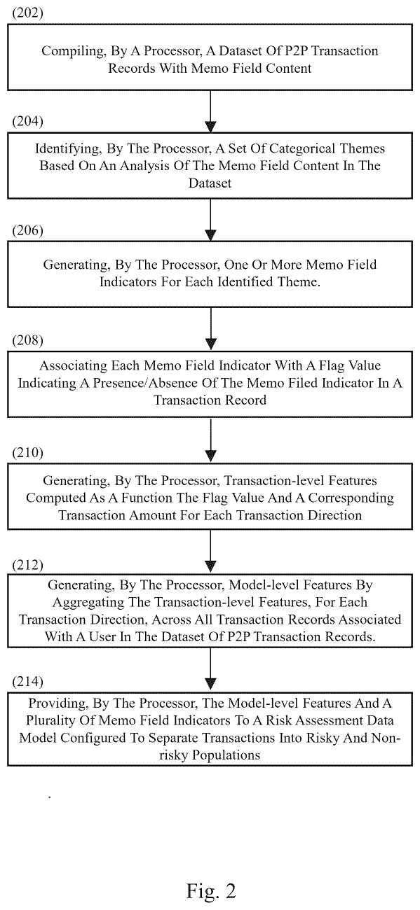

FIG. 2 illustrates an exemplary operational flow diagram of an exemplary process 200 for optimizing risk detection models using data associated with memo field of P2P transaction. In some embodiments the risk detection model may be optimized for identification of transactions and transactional activities associated with anti-money laundering (AML) risk. The exemplary process 200 may start at step 202 corresponding to compilation, by a processor, of one or more raw datasets comprising of P2P transaction records with corresponding memo field content. One example source for acquisition of such P2P transaction records may be a digital payment network. Once the P2P transaction records comprising a memo data field are compiled, the memo field contents, associated with the P2P transaction records, in the dataset may be processed and analyzed, at step 204 for derivation of a set of categorical themes for characterization of the memo field data. In consideration of the often arbitrary and non-descriptive nature of memo field data, some embodiments may implement specific data processing operations to optimize memo field data format for extraction of thematic information and generation of categorical themes therefrom.

Based on an analysis of text associated with the identified and/or derived categorical themes, one or more memo field indicators are determined, for each identified theme, at step 206. At step 208 each memo field indicator is associated with a flag parameter, value of which indicates a presence/absence of the memo field indicator in a transaction record. Accordingly, transaction records may be augmented to indicate a flag value for one or more memo field indicators determined to be present in a corresponding memo field.

At step 210, a set of transaction level features are computed as a function the flag value and a corresponding transaction amount for each transaction direction, as determined from the transaction data associated with the P2P transaction records. Following the generation of transaction-level features for the P2P transaction records, the processor may initiate, at step 212, generation of model-level features by aggregating the transaction-level features, for each transaction direction, across all transaction records associated with a user in the dataset of P2P transaction records.

At step 214 the processor may provide the generated model-level features (comprising a hybrid textual-transactional statistical signal) and a plurality of memo field indicators to a risk assessment model configured to separate transactions into risky and non-risky populations. In some embodiments the risk assessment model may be implemented using one or more machine-learning (ML) protocols. Other embodiments of the risk assessment model may correspond to a standalone algorithm and/or a rule-based model optimized for direct triggering of risk-based transaction alerts.

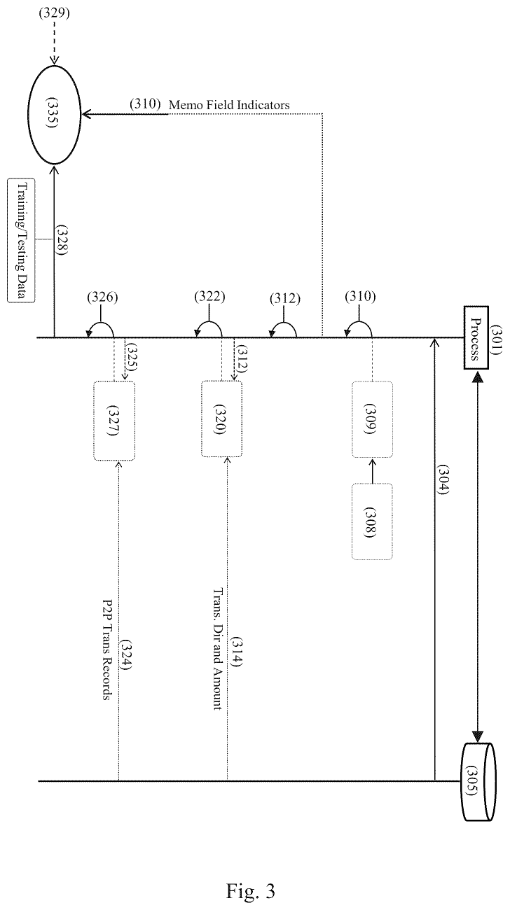

FIG. 3 illustrates a timing sequence diagram for an exemplary process 300 directed at generation of textual-statistical signal from analysis of memo content and transactional context associated with P2P transactions. In accordance with some embodiments the textual-statistical signal generated using a previously unexplored data feature associated with P2P online transactions, namely the textual content provided in a transaction memo field, may be used for optimizing an anti-money laundering (AML) risk detection and/or assessment model. As described above the memo field data may be further analyzed in context of other transactional features such as transaction direction and corresponding transaction amount in generation of input features for training and testing of risk model (e.g., transaction associated with AML risk).

Accordingly, an aspect of the disclosure involves statistical transform of the P2P memo field and aggregate transaction behavior of the relevant parties for generation of a risk signals associated with suspicious activity (e.g., AML risk). In accordance with one embodiment of the present disclosure, a semi-supervised learning process may be implemented to convert memo field data content into one or more parameters that may be combined with transactional context data to generate a textual-statistical signal. The textual-statistical signal may then be used, for example, to train a machine-learning risk assessment model.

Referring back to example 300, a process 301 is implemented for generation of risk model input parameters from analysis of transaction memo fields and other transactional context. one primary component of the exemplary process 300, involves construction of thematic categories (e.g., by a memo categorizer process 309) from analysis of memo fields, extracted from P2P transaction records 304 retrieved from a P2P transaction repository 305. Generation of memo field indicators 310 may involve a corresponding adaptations of data processing features (e.g. at 308) for enabling the generation of categorical memo themes (e.g., by a memo categorizer process 309) and subsequent generation of memo field indicators (e.g., at 310).

It is noted that the memo field categorizer process 309 and memo data preprocessing unit 308 may be implemented as sub-processes running as part of process 301. In some embodiments, memo field categorizer process 309 and memo data preprocessing unit 308 may be separate processes communicatively coupled with process 301. In some embodiments, memo field categorizer process 309 and memo data preprocessing unit 308 may involve a human component for performance of the required memo field data assessment and analysis.

Referring back to example 300, following generation and/or derivation of memo field indicators at 310, process 301 may assign indicator flags to each of the generated memo field indicators at 312. Specific implementation of transaction flagging, based on memo indicator flag assignments at 312 (e.g., association of corresponding memo indicators with a flag value) enables the incorporation of memo content related feature into the risk assessment analysis as further discussed below.

Another primary component of the exemplary process 300 involves generation of transaction-level features (e.g., by a transaction-level feature generation process 320) using, in part, the indicator flags (e.g., generated at 312) and transaction-level data 314, such as transaction direction and amount, extracted from P2P transaction records 304. In one embodiment, generation of transaction-level features may involve bringing memo-related information (310, 312) at a transaction-level (e.g., generated at 322) to a user level and combining the memo information with the context of the transaction activity (e.g., at 314). Accordingly, aforementioned aspect of the exemplary implementation 300, involves operations of a transaction-level feature generator 320 in engineering of the memo field features (associated with steps 310 and 312), in combination with transaction attributes 314, into transactional-level features 322, which may serve as intermediary parameters for generation of memo-based model-level features. It is noted that the transaction-level feature generation process 320 may be implemented as a sub-process and/or sub-routine running as part of process 301. In some embodiments, transaction-level feature generation process 320 may be a separate process communicatively coupled with process 301.

Accordingly, another primary component of the exemplary process 300 involves processing of the intermediary parameters, corresponding to transaction-level features 322, into a set of input model-level parameters 328 engineered based on transaction memo contents (as represented by memo indicator flags 312) and other transaction attributes (e.g., 314). In accordance with the exemplary embodiment illustrated in FIG. 3, generation of model-level features may be carried out (e.g., via a model-level feature generation process 327) by aggregation of transaction-level features, for each memo indicator parameter 310, across all transactions records 324 associated with a user and/or one or more user account. It is noted that the model-level feature generation process 327 may be implemented as a sub-process and/or sub-routine running as part of process 301. In some embodiments model-level feature generation process 320 may be a separate process communicatively coupled with process 301.

Referring back to example 300, transaction-level feature aggregation at step 326 provides an input signal 328 which represents aggregated transaction-level features for each memo category (as identified by memo field indicators and corresponding indicator flag values in steps 310 and 312, respectively). The input signal 328 (e.g., model-level input parameter), along with various memo field indicator values 310, may then be used as input datasets for training and testing a customized supervised risk assessment model 335 (this may further assist in better understanding the predictive power of memo field features in relation to suspicious activity).

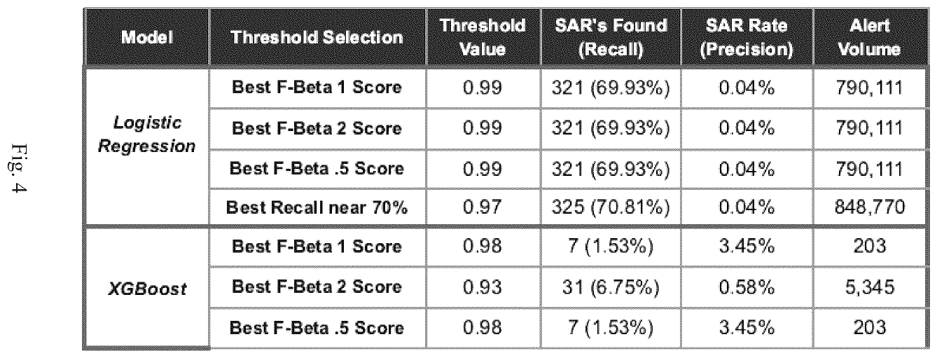

To understand the relation for the model-level features described above with target variable SAR, in one exemplary empirical trial, two algorithms, Logistic Regressions and XGBoost were used to analyze hyperparameter tuning and features importance for optimizing performance of the data model (e.g., data model 335) and identify the most influential model-level features. An exemplary empirical results for performance of the data model 335 in terms of the model-level feature set is provided in FIG. 4.

In some embodiments, a model output, that is predictive of a strong relationship between features engineered from memo field content and a suspicious activity label, may be subject to additional reviews by a human investigator to check for indirect correlations between features engineered from memo field content and a suspicious activity label, generated by the model 335. Accordingly, example 300 illustrates an additional input signal 329, based on investigator review of positive correlations generated by data model 335.

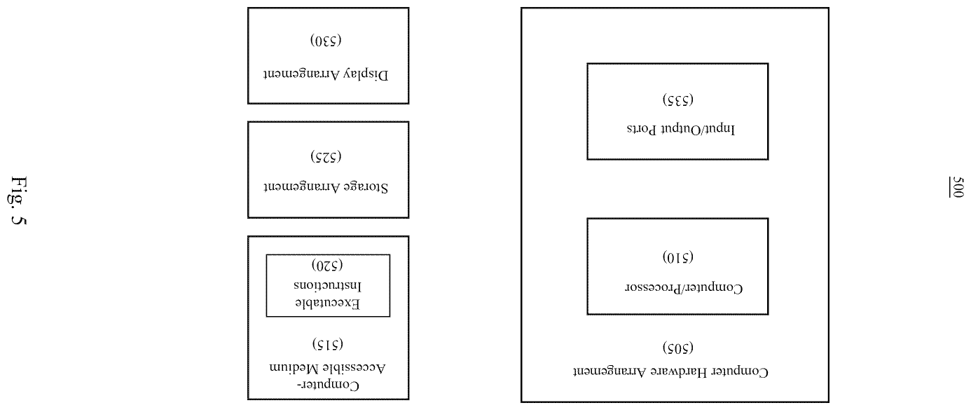

FIG. 5 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 505) may be configured for computing a trajectory of the contactless card within an optical field of view generated by a camera unit of user device and projecting a final placement of the contactless against a reader unit of the user device at a point at which the camera feed goes dark). Such processing and/or computing arrangement 505 can be, for example entirely or a part of, or include, but not limited to, a computer and/or processor 510 that can include, for example one or more microprocessors, and use instructions stored on a computer-accessible medium (e.g., RAM, ROM, hard drive, or other storage device).

As shown in FIG. 5, for example a computer-accessible medium 515 (e.g., as described herein above, a storage device such as a hard disk, floppy disk, memory stick, CD-ROM, RAM, ROM, etc., or a collection thereof) can be provided (e.g., in communication with the processing arrangement 505). The computer-accessible medium 515 can contain executable instructions 520 thereon. Additionally or alternatively, a storage arrangement 525 can be provided separately from the computer-accessible medium 515, which can provide the instructions to the processing arrangement 505 so as to configure the processing arrangement to execute the exemplary procedures, processes, and methods, as described herein above, for example.

Further, the exemplary processing arrangement 505 can be provided with or include an input and/or output ports 535, which can include, for example a wired network, a wireless network, the internet, an intranet, a data collection probe, a sensor, etc. As shown in FIG. 5, the exemplary processing arrangement 505 can be in communication with an exemplary display arrangement 530, which, according to certain exemplary embodiments of the present disclosure, can be a touch-screen configured for inputting information to the processing arrangement in addition to outputting information from the processing arrangement, for example. Further, the exemplary display arrangement 530 and/or a storage arrangement 525 can be used to display and/or store data in a user-accessible format and/or user-readable format.

Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method of evaluating risk footprint, the method comprising:
compiling, by a processor, a dataset of transaction records with memo field content;
identifying, by the processor, a set of categorical themes based on an analysis of the memo field contents in the dataset;
generating, by the processor, one or more memo field indicators for each identified theme, wherein each memo field indicator is associated with a flag value indicating a presence or absence of the memo field indicator in a transaction record;
generating, by the processor, one or more transaction-level features based on a direction of the transaction record, wherein the transaction-level features are computed as a function the flag value and a corresponding transaction amount for each transaction direction;
generating, by the processor, one or more model-level features by aggregating the one or more transaction-level features based on the direction of a transaction record across all transaction records associated with a user in the dataset of transaction records; and
providing, by the processor, the one or more model-level features and a plurality of memo field indicators to a risk assessment model configured to generate a hybrid textual-transactional statistical signal to separate transactions into risky and non-risky populations.

2. The method of claim 1, wherein generating one or more memo field indicators for each identified theme comprises identifying one or more terms associated with each categorical theme by searching the memo fields for a pattern of words associated with each theme.

3. The method if claim 1, wherein model-level features comprise an aggregate transaction count and a corresponding aggregate transaction amount associated with each categorical theme, wherein the aggregate transaction count and the aggregate transaction amount for each categorical theme is computed for each transaction direction corresponding to incoming and outgoing transactions associated with the user.

4. The method of claim 1, wherein the risk assessment model is trained to identify a baseline pattern of transaction attributes associated with each identified memo theme, for the user, and isolate transactions that violate the baseline pattern between the identified memo themes and transaction attributes.

5. The method of claim 1, wherein the analysis of memo field contents comprises compiling a list of most repeated words in the memo fields associated with the dataset of transaction records.

6. The method of claim 5, wherein compiling a list of most repeated words comprises performing intra and inter memo word frequency analysis on parsed memo field content to generate a list of words that meet the trade-off of having a sufficient common occurrence while also representing a sufficient amount of the memo population.

7. The method of claim 1, wherein the analysis of memo field contents comprises identifying one or more key risk terms in the memo field content of the dataset that correspond to memo field contents in known fraud cases.

8. The method of claim 7, wherein the one or more key risk terms are associated with non-numeric, non-date key risk terms with four or more characters.

9. The method of claim 1, wherein plurality of categorical themes comprises one or more theme associated with a presence of one or more negative words in a memo field, the one or more negative words in the memo field being identified using a negative sentiment lexicon pattern based on a predetermined threshold.

10. The method of claim 1, wherein the one or more transaction-level features, computed for each of the plurality of themes based on the transaction direction, corresponds to the flag value and a product of the flag value with the corresponding transaction amount.

11. The method of claim 10, wherein a transaction amount corresponding to outgoing and incoming transactions are associated with different limits.

12. The method of claim 1, wherein the generation of one or more transaction-level features corresponds to computation of four transaction-level features for each identified theme.

13. The method of claim 12, wherein the generation of one or more model-level features corresponds to computation of six model-level features for each identified theme.

14. The method of claim 13, wherein the one or more model-level features represents a consolidated view of a total incoming amount and a total outgoing amount associated with each memo field indicator for the user.

15. The method of claim 1, wherein the risk assessment model, for determining a relationship between memo field indicators and transactional features, is trained using an ensemble tree technique.

16. A system, comprising:
a processor; and
a memory storing instructions which when executed by the processor, cause the processor to:
identify a set of categorical themes based on analysis of memo fields associated with a dataset of transactions;
generate oner or more memo field indicators for each identified theme, wherein each memo field indicator is associated with a flag value indicating a presence or absence of the memo field indicator in a transaction record;
generate one or more transaction-level features, based on a direction of the transaction record, wherein the transaction-level features are computed as a function the flag value and a corresponding transaction amount, for each transaction direction;
generate one or more model-level features by aggregating the one or more transaction-level features based on the direction of a transaction record across all transaction records associated with a user in the dataset of transaction records; and
provide the one or more model-level features and a plurality of memo field indicators to a risk assessment model configured to generate a hybrid textual-transactional statistical signal to separate transactions into risky and non-risky populations.

17. The system of claim 16, wherein, wherein model-level features comprise an aggregate transaction count and a corresponding aggregate transaction amount associated with each categorical theme, wherein the aggregate transaction count and the aggregate transaction amount for each categorical theme is computed for each transaction direction corresponding to incoming and outgoing transactions associated with the user.

18. The system of claim 16, wherein the risk assessment model is trained to identify a baseline pattern of transaction attributes associated with each identified memo theme, for the user, and isolate transactions that violate the baseline pattern between the identified memo themes and transaction attributes.

19. The system of claim 18, wherein the one or more transaction-level features, computed for each of the plurality of themes based on the transaction direction, corresponds to the flag value and a product of the flag value with the corresponding transaction amount, and wherein a transaction amount corresponding to outgoing and incoming transactions are associated with different limits.

20. A non-transitory computer-readable medium containing executable instructions, wherein, when executed by a processor, the instructions cause the processor to perform procedures comprising:
identifying a set of categorical themes based on analysis of memo fields associated with a dataset of peer-to-peer transactions;
generating one or more memo field indicators for each identified theme, wherein each memo field indicator is associated with a flag value indicating a presence or absence of the memo field indicator in a transaction record;
generating one or more transaction-level features, based on a direction of the transaction record, wherein the transaction-level features are computed as a function the flag value and a corresponding transaction amount for each transaction direction;
generating one or more model-level features by aggregating the one or more transaction-level features based on the direction of a transaction record across all transaction records associated with a user in the dataset of transaction records; and
providing the one or more model-level features and a plurality of memo field indicators to a risk assessment model configured to generate a hybrid textual-transactional statistical signal to separate transactions into risky and non-risky populations.
